(19) United States
(12) Patent Application Publication
(10) Pub. No.: US 2012/0218764 A1
(43) Pub. Date: Aug. 30, 2012

(54) LED light fixture assemblies for general use

(75) Inventors: Michael H. Williamson, Vancouver (CA); Herb E. Williamson, Vancouver (CA)

(73) Assignee: LIGHT POWER CANADA INC.

(21) Appl. No.: 12/932,497

(22) Filed: Feb. 28, 2011

(51) Int. Cl. F21V 29/00

(52) U.S. Cl. 362/294

(57) ABSTRACT

The assembly comprises a reflector housing subassembly incorporating a shell having a surface area for heat dissipation and a LED light source providing a prerequisite lumen output. A correlation of the surface area and the lumen output with a thickness of the shell, made generally of aluminum alloy, allows the shell to function as a heat sink. In the case of a conventional 6 in Pot Light, the assembly includes a reflector made of aluminum alloy with a gauge thickness of 1.5-1.63 mm. The LED light source is supplied by a 12 W power. For a parking garage area lightening assembly, a reflector with a bottom opening of 13 in×13 in and made of aluminum alloy with a gauge thickness of 1.5-1.63 mm is used. The LED light source has at least 2000 lumens and operates at least at 40 W.

### I. BACKGROUND OF THE INVENTION

1. Field of the Invention

The present invention relates generally to LED light fixtures, and, more particularly, to LED light fixture assemblies for general use, which can be used in both new constructions and for retrofitting applications into incandescent or fluorescent light fixture assemblies.

2. Description of the Prior Art

There is a general tendency to replace incandescent lamps with LED light fixtures. Incandescent lamps burn out rapidly, leading to high costs for the users. In buildings with high ceilings, such as in museums, hotels, churches etc., changing the lamps is a difficult operation. Substituting LED light fixtures for incandescent lamps would remediate the foregoing disadvantages. Moreover, LED light fixtures are compact, require significantly reduced power, develop comparatively reduced heat, provide high luminosity using a small structure and, finally, have a working life lasting for thousands of hours.

Although the aforementioned qualities are incontestable, there is an important problem that the existing LED light fixtures are facing. This problem resides in the use of separate heat sinks which are cumbersome and costly.

A first example, U.S. Pat. No. 7,677,770, granted on Mar. 16, 2010 to Mazzochette for a “Thermally-Managed Led-Based Recessed Down Lights” describes a subassembly for removing heat generated by a LED source. The subassembly includes 1) a fan arranged between a ventilation cone and a housing for moving air from within the ventilation cone and past a LED light source and 2) a heat sink in thermal communication with the LED source and mounted between the ventilation cone and the fan. A second example, U.S. Pat. No. 7,614,769, granted on Nov. 10, 2009 to Sell for a “LED Conversion System For Recessed Lighting” discloses a thermal insulation juxtaposed with a shell. The shell is made of molded plastic, especially structural foam, which imparts strength and thermal insulation. A seal is disposed between the shell and a panel. The seal is made of a elastomer material, so as to conform closely to the shell and the panel. The seal is adapted to minimize air flow through an interspace between the shell and the panel. Another example United States Patent Application Publication No. 2009/0086476, published on Apr. 2, 2009 on the name of Tickner et al. for a “Light Emitting Diode Recessed Light Fixture” discloses a heat sink for dissipating heat from LEDs. The heat sink includes a core member from which fins extend. Each fin includes one or more straight and/or curved portions. A reflector housing is coupled to the heat sink and configured to receive a reflector.

### H. SUMMARY OF THE INVENTION

In order to eliminate the above problem, the inventor sets forth the following objectives:
1. A first objective is to eliminate the use of a heat sink, as a separate feature of LED light fixture assemblies for general use ; thus, the simplicity is evident and, as a result, the weight of assemblies, which are always suspended, could be reduced; and
2. A second objective is to employ, as much as possible, the existing conventional configurations in order to simplify the retrofitting applications.

Broadly stating, a LED light fixture assembly for general use, according to the present invention, comprises

a reflector housing subassembly incorporating a shell having a surface area for heat dissipation and;

a LED light source providing a prerequisite lumen output;

a correlation of the surface area and the lumen output with a thickness of the shell, generally made of alluminium alloy, allows the shell to accomplish a heat sink role.

In one aspect, a LED light fixture assembly for general use, in the case of a conventional 6 in Pot Light, includes a reflector having an internal surface of 70.5 in², made of aluminum alloy (AISI 6061 T6) with a gauge thickness of 1.5-1.63 mm and a LED light source supplied by a power 12 W.

In another aspect, a LED light fixture assembly for general use, in the case of a LED parking garage area lighting assembly which uses a reflector having an opening of 13 in×13 in with a reflecting surface of 530 in², made of aluminum alloy (AISI 6061 T6) with a gauge thickness of 1.5-1.63 mm and a LED light source operating at a wattage of at least 40 W (approx. 2,000 lumen).

### III. BRIEF DESCRIPTION OF THE DRAWINGS

While the features of LED light fixture assemblies for general use of the present invention are set with particularity in the appended claims, a full and complete understanding of the present invention may be had by referring to the detailed description of the preferred embodiments as subsequently described and illustrated in the accompanying drawings in which:

FIG. 1 is a perspective view of an LED light fixture assembly for general use devised in accordance with the present invention;

FIG. 2 is a front elevational view of the LED light fixture assembly of general use, devised in accordance with the present invention and depicting the assembly located in a can-shaped receptacle and placed against a ceiling (power supply box and first and second pair of conductors not shown);

FIG. 3 is an exploded, perspective view of the LED light fixture assembly of general use, devised in accordance with the present invention (power supply box and first and second pair of conductors not shown);

FIG. 4 is a front elevation view of the LED light fixture assembly, as shown in FIG. 2, to which a downward extension is attached;

FIG. 5 is a perspective view of the downward extension shown in FIG. 4;

FIG. 6 is a vertical cross-section of the assembly shown in FIG. 4, without the can-shaped receptacle and the ceiling, before the downward extension is secured;

FIG. 7 depicts, using an enlarged scale, a local zone A shown in FIG. 6;

FIG. 8 is a vertical cross-section of the assembly shown in FIG. 4, without the can-shaped receptacle and the ceiling, after the downward extension is secured;

FIG. 9 depicts, using an enlarged scale, a local zone B shown in FIG. 8; and

FIG. 10 is an exploded, perspective view of a LED parking garage area lighting assembly devised in accordance with the present invention (power supply box and first and second pair of conductors not shown).

### IV. DESCRIPTION OF THE PREFERRED EMBODIMENTS

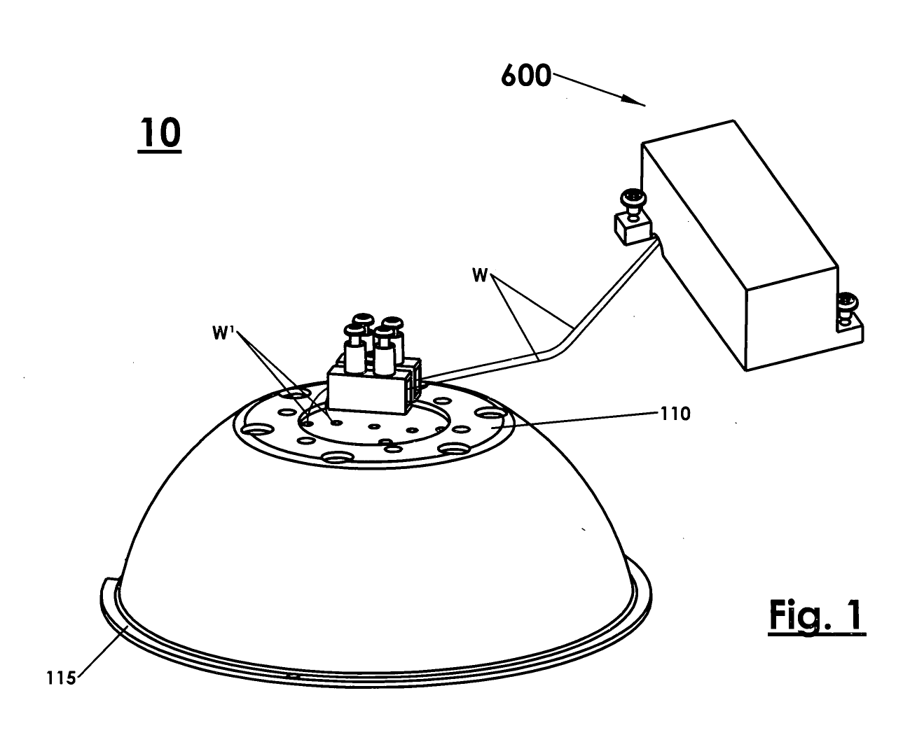

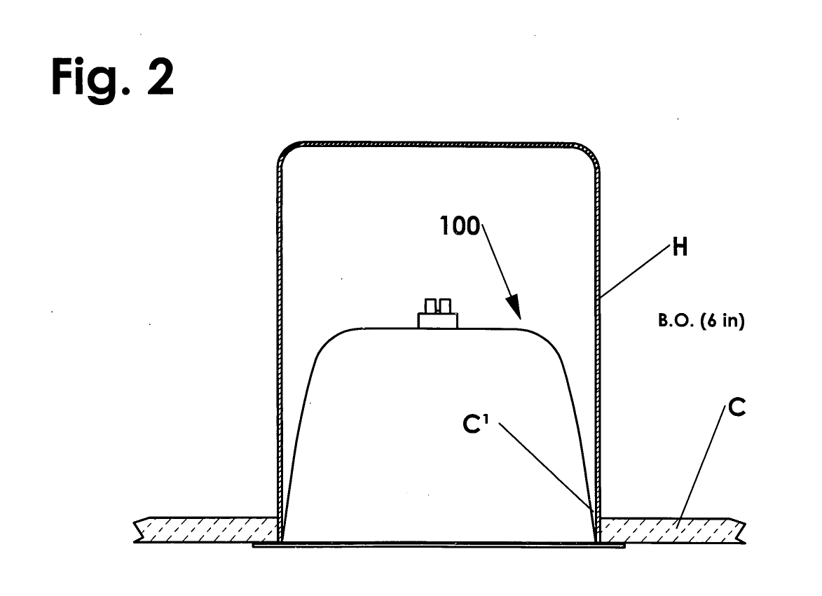

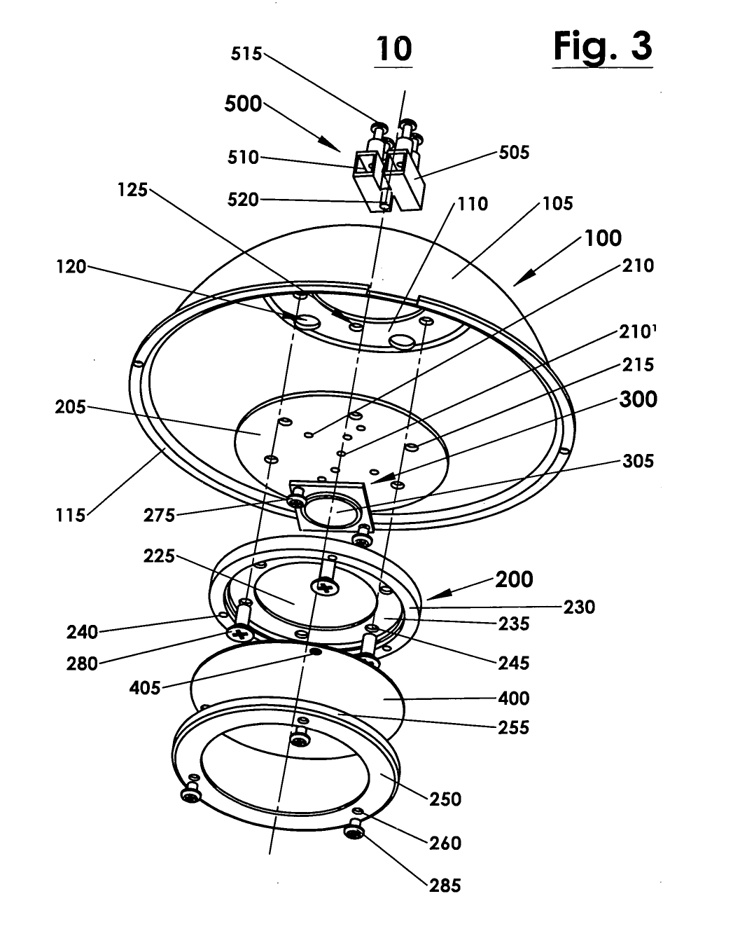

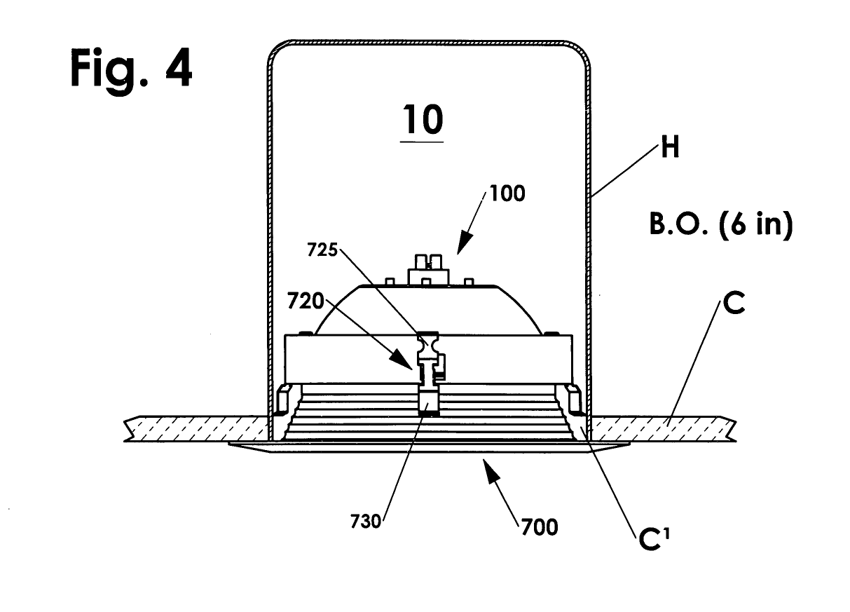

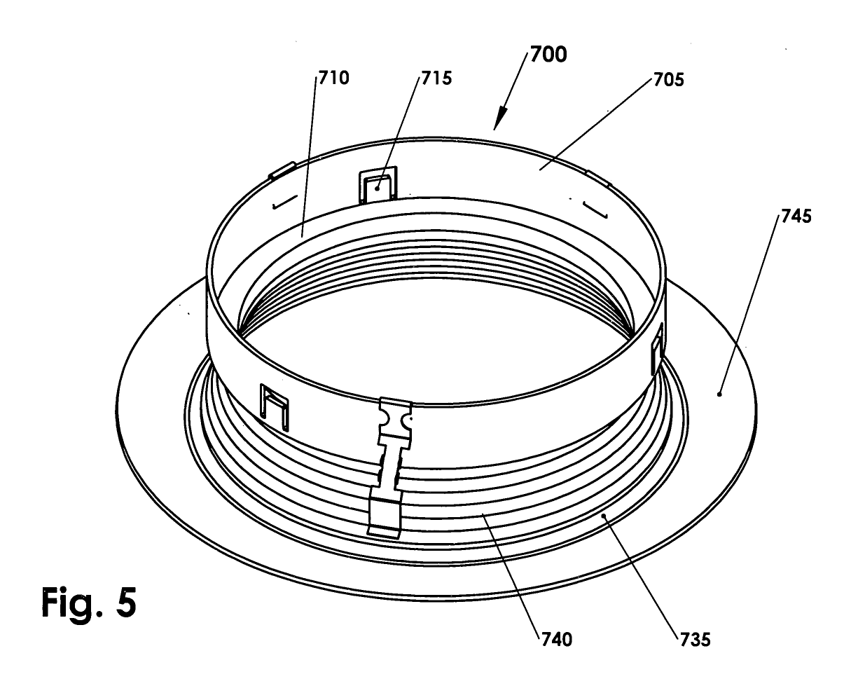

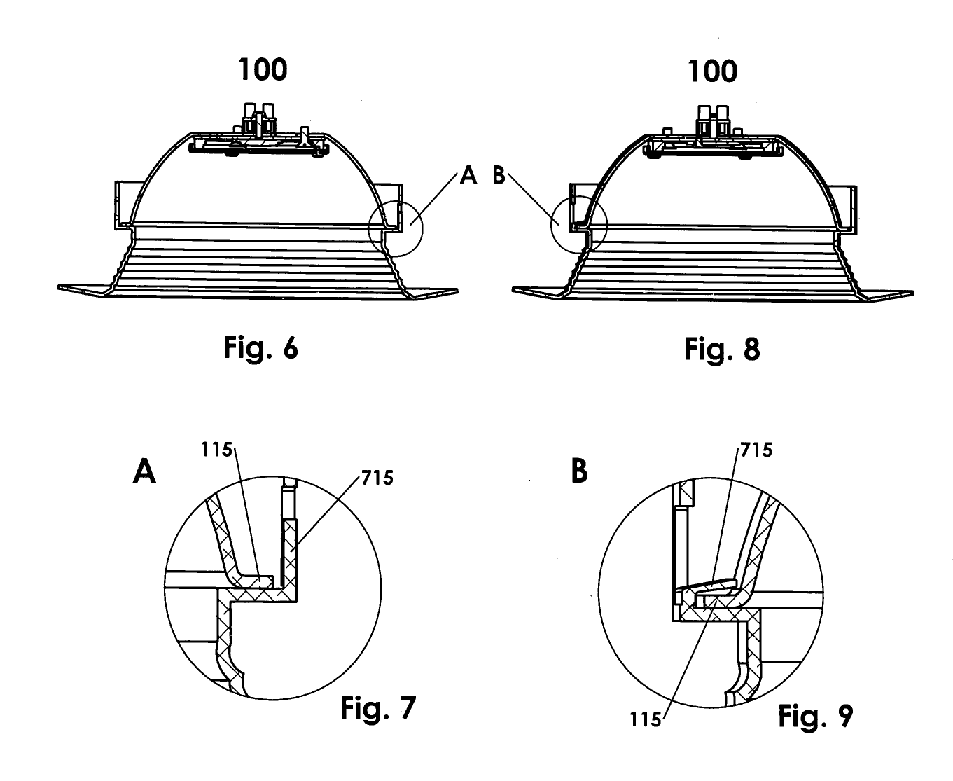

Referring now to FIGS. 1 to 9, a LED light fixture assembly for general use 10, according to the present invention, comprises
a reflector housing subassembly 100 incorporating a dome-like shell 105;
an attachment subassembly 200, horizontally secured⁻inside, at a top of dome-like shell 105;
a LED array package 300, having one or or more LEDs, constitutes a light source;
a light diffuser lens 400 extending in parallel and beneath LED array package 300; the latter and the former, respectively LED array package 300 and light diffuser lens 400 are incorporated in and held in place by attachment subassembly 200;
an electrical socket 500 placed externally on a top on dome-like shell 105; and
a power supply box 600, located in can shaped receptacle H, outside LED recessed down light fixture assembly 10;
a first pair of conductors W connecting power supply box 600 with electrical socket 500; and
a second pair of conductors W¹ connecting electrical socket 500 with LED array package 300.

Describing now in detail, LED light fixture assembly 10 of a conventional 6 in Pot Light (the diameter of a bottom opening B.O. of dome-like shell 105 being 6 in), uses
reflector housing subassembly 100 that includes dome-like shell 105, which extends at is upper side into a flat horizontal top 110 and at is lower side into a flat, horizontal, annular flange 115 that encircles bottom opening B.O. of dome-like shell 105 and to which it is permanently secured; flat, horizontal annular flange 115 is placed against ceiling C, around opening C¹; flat horizontal top 110 is traversed by several, relatively large, vent apertures 120 for escaping hot air and several threaded apertures 125; apertures 120 and 125 are, respectively, circularly disposed;

in the present embodiment, reflector housing subassembly 100 is, in general, made of aluminum, specifically aluminum alloy (AISI 6061 T6) has been chosen due to its 1) adequate malleability to form the shapes corresponding to the embodiments disclosed in the present specification; 2) due to its thermal conductivity which assures—continuous and efficient heat dissipation with little spreading resistance and elongation, without using a separate heat sink and, finally, 3) due to its structural rigidity that is required during fabrication, handling, installation, frequent surface dirt cleaning, etc.;

the use of a gauge thickness, generally of 1.5-1.63 mm for reflector housing subassembly 100, notably for dome-like shell 105, was, basically, determined by testing, for the purpose of correlating 1) an established surface area of approx. 70.5 in² of a conventional 6 in Pot Light and 2) a prerequisite by an user lumen output of LED array package 300 with 3) a gauge thickness of reflector housing subassembly 100, respectively its dome-like shell 105;

alternatively, other metals, easy to manufacture, with high heat diffusion and reduced weight could substitute aluminum alloys.

As can be inferred from the foregoing paragraph, a dome-like shell 105 with a certain configuration, respectively a surface area, is able to use its configuration, respectively its body, as a heat sink, as long as the thickness of this configuration, respectively of its surface area, in the present embodiment of dome-like shell 105, is appropriately adjusted/dome-like shell 105 with a certain configuration, respectively a surface area, and a prerequisite by an user lumen output of LED array package 300 being already selected/;

inside surface area of dome-like shell 105, being used for reflecting, refracting, transmitting or diffusing light from LED array package 300, can comprise specular, semi-specular, semi-diffuse, or diffuse finish;

in the embodiments described in the present specification, anodized finish, which provides the following performances, was adopted:

durability/relatively extended life span/;

color stability/do not chip or peel/;

easy maintenance/no special requirements/;

aesthetics/offers a large number of gloss and color alternatives and minimizes or eliminates color variations/; and

cost/low initial finishing cost combined with lower maintenance cost/;
attachment subassembly 200 comprises perforated upper disk 205, having a thickness substantially commensurate with the thickness of dome-like shell 105, is provided with two threaded, diametrically opposite holes 210 and one central threaded hole 210′ and several through holes 215, circularly disposed (their use will be indicated in the forthcoming disclosure); perforated disk 205 has a circumference that is adaptable to fit and be superposed on flat horizontal top 110;

a stepped ring 220 of unitary construction is provided with 1) a central, circular, through opening 225 for capturing LED array package 300; 2) an external, thicker ring 230 and an internal thinner ring 235; 3) several threaded blind openings 240, disposed circularly into external, thicker ring 230; and 4) several through openings 245 disposed in internal thinner ring 235; and a bottom securing ring-cap 250, having a perpendicularly upward edge 255, is used for lodging light diffuser lens 400; bottom securing ring-cap 250, traversed by several passing apertures 260 is attached to stepped ring 220;
LED array package 300 is electrically coupled to power supply box 600 via electrical socket 500; LED array package 300 includes one or more LEDs mounted to a common substrate 305; each LED includes a chip of semi-conductive material that is treated to create a positive-negative (“p-n”) junction. When LED array package 300 is electrically coupled to power supply box 600, current flows from the positive side to the negative of each junction, causing charge carriers to release energy in the form of light. The wavelength or color of the emitted light depends on the materials used to make LED array package 300; LED array package 300 can include one or more white LEDs and one or more non-white LEDs, such as read, yellow, amber, or blue LEDs, for adjusting the color temperature output of the light emitted from LED array package 300; the emitted light approximates or emulates “white” incandescent light to a human observer. In practice, the emitted light includes substantially white light that seems slightly blue, green, red, yellow, orange, or some other color or tint; in the embodiments described in

in this specification, LED array packages 300 are produced by Bridgelux Co.;
light diffuser lens 400, used in the described embodiments, is made from a material commercially called “Light Shaping Difusser” or in engineering terms called “Laser embossed holographic diffuser”; the foregoing material is sold on the market under the trademark “Luminit”; the reasons of using Luminit's laser embossed holographic diffuser resides in its ability to allow light pass by unblocked, unreflected or absorbed up to 85 to 92%, in its ability to be embossed onto a variety of different materials (glass, polycarbonate, acrylic, polyester, etc) and, finally, in its ability to expand and contract when heat from LED array package 300 is applied to it; in general, light diffuser lens 400 can be a diffuser, a filter, a fresnel lens, or any element that will pass light from LED array package 300 outward, and process the light as desired; light diffuser lens 400 is provided circularly with several equally spaced holes 405 coinciding with passing apertures 260 of bottom securing ring-cap 250;
electrical socket 500, made of plastic material, is placed on flat horizontal top 110 of dome-like shell 105 and incorporates a pair of horizontal channels 505 wherein a pair of metallic hollow inserts 510 are located; a pair of vertical, spaced screws 515 is threaded in each of the pair of metallic hollow inserts 510;
power supply box 600 is adapted to convert AC current from an external source of 120 (240) V to DC current of 12V and 1 A required by LED array package 300; for conventional 6 in Pot Light, the required power is substantially 12 W; the wattage can be raised to increase brightness; in this case, gauge thickness of reflector housing subassembly 100, notably of dome-like shell 105 must be adjusted;
first pair of conductors W, connecting power supply box 600 with electrical socket 500, is secured into the pair of horizontal channels 505, respectively into the pair of metallic hollow inserts 510, by a pair of vertical, spaced screws 515;
second pair of conductors W¹, connecting electrical socket 500 with LED array package 300, is secured into the pair of horizontal channels 505, respectively into the pair of metallic hollow inserts, by a pair of vertical, spaced screws 515;
means is provided for mounting attachment subassembly 200 to electrical socket 500 and to reflector housing subassembly 100; specifically, a central vertical screw 520 passing across electrical socket 500 secures the latter to central threaded hole 210¹ of perforated upper disk 205; a first pair of screws 275 secures LED array package 300 to two threaded, diametrically opposite holes 210; several second screws 280, first, after traversing several through openings 245 disposed in internal thinner ring 235 of stepped ring 220 and, second, after traversing upper disk 205, respectively its several through holes 215, are tightened into flat horizontal top 110 of dome-like shell 105, respectively into its several threaded apertures 125; and several third screws 285, which after first traversing bottom securing ring-cap 250, respectively its passing apertures 260, and, second, after traversing light diffuser lens 400, respectively its several equally spaced holes 405, coinciding with passing apertures 260 of bottom securing ring- cap 250, are finally tightened into stepped ring 220, respectively into several threaded openings 240 of external, thicker ring 230;

In a certain exemplary embodiment, use is made of a downward extension 700 to LED light fixture assembly 10, specifically to dome-like shell 105. Downward extension 700 is a unitary part, generally formed from the same type of aluminium and with the same thickness as reflector housing subassembly 100.

To accomplish this use, LED recessed down light fixture assembly 10 is so lifted that flat, horizontal annular flange 115, instead of being placed against ceiling C, is spaced upward from the latter.

Downward extension 700 comprises, at its upper part, a hollow cylinder 705 having the internal diameter somewhat larger than the diameter of horizontal annular flange 115. Hollow cylinder 705 extends, at its bottom, horizontally and inwardly, into a rim 710 on which horizontal annular flange 115 is supported (when assembled). Hollow cylinder 705 is provided with several equally spaced rectangular tabs 715, each of the latter having three sides cut out/top and lateral sides/from hollow cylinder 705, while its lower part extends from a bottom of hollow cylinder 705. When horizontal annular flange 115 is already supported on rim 710, the several equally spaced rectangular tabs 715 are inwardly bended to contact horizontal annular flange 115 (see FIG. 9).

Several clips 720, made of springy metal, are circumferentially, equally spaced along hollow cylinder 705. Each one of the several clips 720 has un upper zone 725, folded on itself so, as to be snugly penetrated by an upper portion of hollow cylinder 705 and and a lower zone 730 extending downwardly and outwardly. The role of the several clips is to position and tensively retain reflector housing subassembly 100, together with downward extension 700 attached to it, into can shaped receptacle H.

Downward extension 700 comprises, at its lower part, beneath hollow cylinder 705, a hollow, conical frustum 735 having a shape of a corrugated lateral wall 740. The parallel ridges and channels of the latter are formed by cold-rolling. A flat ring 745 extends outwardly and horizontally from a bottom of hollow, conical frustum 735.

Among several advantages provided by downward extension 700, the following three could be considered as salient:
enhanced heat dissipation due to an extended surface area, especially due to that of the corrugations, and, moreover, due to a greater thickness of the sheet aluminum, in comparison with that used in conventional light fixtures;
improved body rigidity; and
aesthetically pleasing aspect.

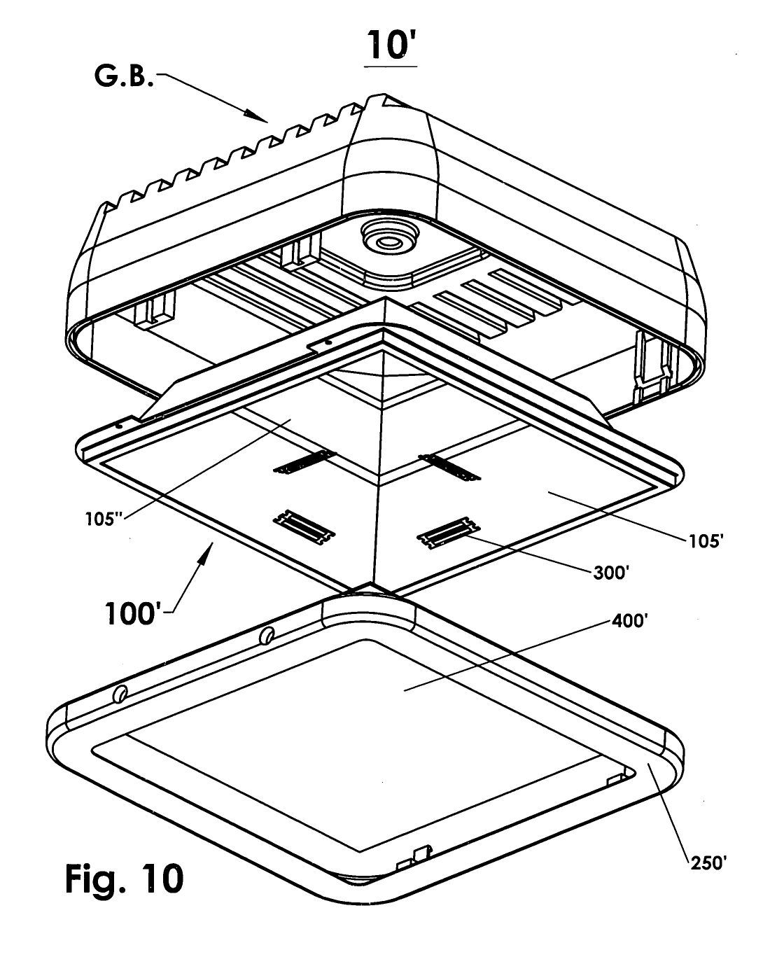

In another exemplary embodiment (see FIG. 10), a LED parking garage area lighting assembly 10′, devised on the same inventive concept as the previously described embodiments, uses an existing garage light “can” base G.B. Thus, LED parking garage area lighting assembly 10′ is affixed or retrofitted inside of an existing garage light “can” base G.B., wherein a power supply box (not shown) is secured.

Succinctly describing the components of LED parking garage area lighting assembly 10′ (see FIG. 10) in view of previously disclosed embodiments, a garage reflector subassembly 100′ that includes a first hollow trapezoidal prism-like reflector 105′ extending upwardly into a second hollow trapezoidal prism- like reflector 105″. First hollow trapezoidal prism-like reflector 105′ is substantially larger than second hollow trapezoidal prism- like reflector 105″. The former and the latter forms an unit with a bottom opening of 13 in×13 in and an internal surface of approx. 530 in². The unit formed by first hollow trapezoidal prism-like reflector 105′ and second hollow trapezoidal prism-like reflector 105″ is removably secured to existing garage light “can” base G.B.

A light diffuser lens 400′ is positioned to cover a bottom opening of first hollow trapezoidal prism-like reflector 105′. Light diffuser lens 400′, used in the present embodiment, is made of polycarbonate. A rectangular bottom frame 250′ surrounds and captures light diffuser lens 400′ for removably attaching the latter, via first hollow trapezoidal prism-like reflector 105′, to pre-existing garage light “can” base G.B.

A LED array package 300′ is placed on each inclined plane of first hollow trapezoidal prism-like reflector 105′. The four LED array packages 300′ are connected to a power supply box (not shown).

Similarly, like in a previous embodiment, in the last embodiment, garage reflector subassembly 100′ is made of aluminum alloy (AISI 6061 T6) having a gauge thickness, generally of 1.5-1.63 mm; this was basically determined by routine testing in order of correlating 1) an established surface of light reflecting and heat dissipation of a conventional garage reflector subassembly 100′ of LED parking garage area lighting assembly 10′ and 2) a prerequisite lumen output of LED array packages 300′ with 3) a gauge thickness of garage reflector subassembly 100′.

As can be inferred from the foregoing paragraph, in this case as well, in any LED recessed down light fixture, with a prerequisite lumen output and wattage, it is possible to use the body configuration having a certain surface area as a heat sink, as long as the aluminum thickness of this reflector's body is adequately adjusted.

The invention can be materialized in other embodiments and also carried out in various ways. Also, it is to be understood that the wording and specific terminology used herein should not be considered as limiting. Accordingly, all suitable modifications and equivalents may be resorted to, fall within the scope of the present invention.

1. (canceled)

2. (canceled)

3. (canceled)

4. A LED light fixture assembly for general use comprising
a reflector housing subassembly incorporating a shell having a surface area for heat dissipation;
a LED light subassembly providing a prerequisite lumen output; and
means for correlating said surface area and said prerequisite lumen output with a thickness of said shell, thereby said shell fulfilling essentially a role of a heat sink.
